(19) United States
(12) Patent Application Publication
(10) Pub. No.: US 2015/0161712 A1
(43) Pub. Date: Jun. 11, 2015

(54) UNIFYING SHOPPING EXPERIENCE SYSTEM

(71) Applicants: Angelo Ponzetta, Kowloon (HK); Wai Shu Wong, Shau Kei Wan (HK)

(72) Inventors: Angelo Ponzetta, Kowloon (HK); Wai Shu Wong, Shau Kei Wan (HK)

(73) Assignees: 12 Retail (HK) Limited, Admiralty (HK); Angelo Ponzetta

(21) Appl. No.: 14/101,486

(22) Filed: Dec. 10, 2013

(51) Int. Cl. G06Q 30/06; G06Q 30/02

(52) U.S. Cl. CPC G06Q 30/0633; G06Q 30/0201

(57) ABSTRACT

A shopping system is provided. The shopping system includes a customer interaction device for communication between a customer and the shopping system, the customer interaction device interacting with the shopping system to conduct an activity in a store. The shopping system also includes an interactive service device located in a store, the interactive service device having a receiving member to receive an identification information of the customer, a displaying member and an interacting device to allow the customer to interact with the shopping system to conduct an activity in the store. The shopping system further includes a unifying shopping cart unit configured to integrate order information of the customer and a tracking system to track the activities of the customer.

### FIELD OF INVENTION

This invention relates generally to systems for shopping system and, more particularly, to shopping systems with enhanced efficiency.

### BACKGROUND

In traditional in store shopping system, a customer may spend certain amount of time on different tasks. FIG. 1 illustrates a check out process in traditional in store shopping system. As shown in FIG. 1, a customer carries items to be purchased to a check out point and request to buy using cash. A sales person may scan products and enter order. The sales person may pack orders and collect payment. Usually, the customer needs to queue to be serviced. When the customer is serviced, the customer may spend time on various tasks such as filling out the information form for delivery. The customer thus may spend a significant amount of time on activities other than shopping itself.

Merchants/Shop owners rely on sales data to analyze sales figures of the items they carry. The sales data are usually collected after items are sold or are a certain period of time. The information on how customers behave in the store is usually not available immediately to the merchants/shop owners. Such information may include the frequency of certain items to be selected for consideration by a customers, the rate of actual purchase to the consideration of certain items.

The disclosed system and process are directed at solving one or more problems set forth above and other problems.

### BRIEF SUMMARY OF THE DISCLOSURE

One aspect of the present disclosure provides a shopping system. The shopping system includes a customer interaction device for communication between a customer and the shopping system, the customer interaction device interacting with the shopping system to conduct an activity in a store. The shopping system also includes an interactive service device located in a store, the interactive service device having a receiving member to receive an identification information of the customer, a displaying member and an interacting device to allow the customer to interact with the shopping system to conduct an activity in the store. The shopping system further includes a unifying shopping cart unit configured to integrate order information of the customer and a tracking system to track the activities of the customer.

Another aspect of the present disclosure provides a shopping process using a shopping system. The process includes creating a customer interaction device for communication between a customer and the shopping system, the customer interaction device interacting with the shopping system to conduct an activity in a store. The process also includes interacting with the customer interaction device using an interactive service device located in a store, the interactive service device having a receiving member to receive an identification information of the customer, a displaying member and an interacting device to allow the customer to interact with the shopping system to conduct an activity in the store. The process further includes integrating order information of the customer in an unifying shopping cart unit and providing service to the customer under the instruction of the shopping system.

Other aspects of the present disclosure can be understood by those skilled in the art in light of the description, the claims, and the drawings of the present disclosure.

### BRIEF DESCRIPTION OF THE DRAWINGS

FIG. 1 illustrates a check out process in traditional in store shopping system;

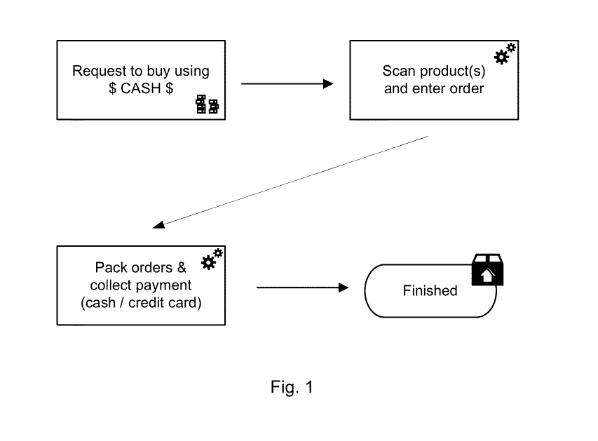

FIG. 2 illustrates an exemplary shopping system consistent with the disclosed embodiments;

FIG. 3 illustrates a block diagram of an exemplary computing system;

FIG. 4 illustrates an exemplary online shopping process consistent with the disclosed embodiments;

FIG. 5 illustrates an exemplary checkout process consistent with the disclosed embodiments;

FIG. 6 illustrates an exemplary mobile app shopping process consistent with the disclosed embodiments;

FIG. 7 illustrates an exemplary mobile app check out process consistent with the disclosed embodiments;

FIG. 8 illustrates an exemplary in store shopping process consistent with the disclosed embodiments;

FIG. 9 illustrates an exemplary in store shopping check out process consistent with the disclosed embodiments;

FIG. 10 illustrates an exemplary service process consistent with the disclosed embodiments;

FIG. 11 illustrates an exemplary pick up process for a customer using an exemplary mobile device;

FIG. 12 illustrates an exemplary iMirror consistent with the disclosed embodiments;

FIG. 13 illustrates a front view of an exemplary iMirror device consistent with the disclosed embodiments;

FIG. 14 illustrates an exemplary display member of an exemplary iMirror device consistent with the disclosed embodiments;

FIG. 15 illustrates an exemplary smart kiosk consistent with the disclosed embodiments;

FIG. 16 illustrates an exemplary detection background removing system consistent with the disclosed embodiments;

FIG. 17 illustrates an exemplary function of the tacking system and the smart kiosk consistent with the disclosed embodiments; and

FIG. 18 illustrates an exemplary function of the tracking system and the iMirror consistent with the disclosed embodiments.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

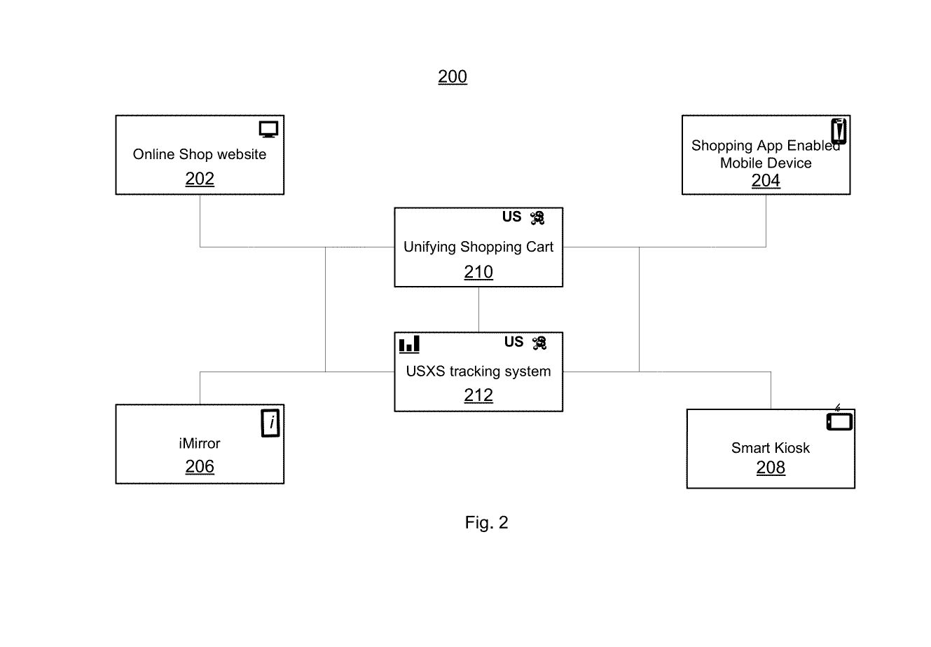

FIG. 2 illustrates an exemplary shopping system 200 consistent with the disclosed embodiments. As shown in FIG. 2, the shopping system 200, which sometimes is designated as the Unifying Shopping eXperience System (USXS), may include an online shopping website 202, a mobile app enabled mobile device 204, an in-store touch screen mirror (iMirrors) 206 and an NFC-enabled tablet computer (Smart Kiosk) 208. These components may be linked by a USXS device tracking system 210 and a unifying shopping cart 210.

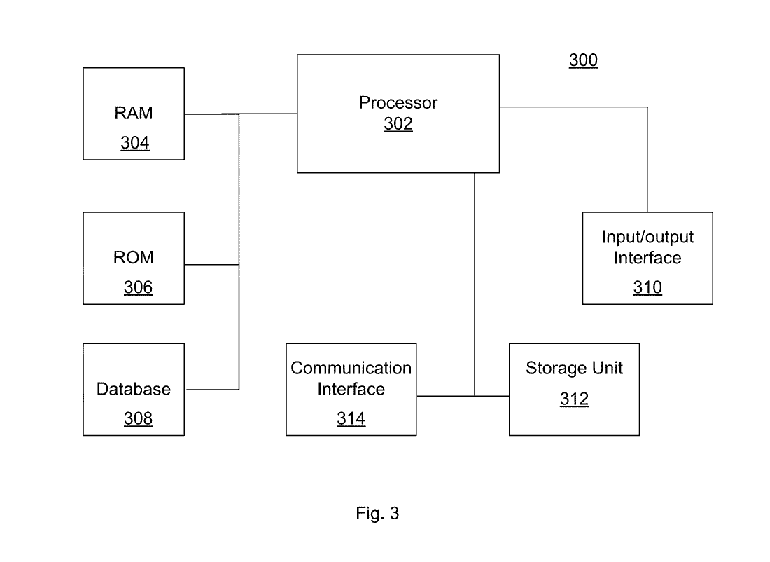

The various components, e.g., the online shopping website 202, the mobile app enabled mobile device 204, the in-store touch screen mirror (iMirrors) 206, the NFC-enabled tablet computer (Smart Kiosk) 208, the USXS device tracking system 210 and the unifying shopping cart 210 may be implemented using any appropriate computing systems. FIG. 3 shows a block diagram of an exemplary computing system 300.

As shown in FIG. 3, computing system 300 may include a processor 302, a random access memory (RAM) unit 304, a read-only memory (ROM) unit 306, a database 308, an input/output interface unit 310, a storage unit 312, and a communication interface 314. Other components may be added and certain devices may be removed without departing from the principles of the disclosed embodiments.

Processor 302 may include any appropriate type of graphic processing unit (GPU), general-purpose microprocessor, digital signal processor (DSP) or microcontroller, and application specific integrated circuit (ASIC), etc. Processor 302 may execute sequences of computer program instructions to perform various processes associated with computing system 300. The computer program instructions may be loaded into RAM 304 for execution by processor 302 from read-only memory 306.

Database 308 may include any appropriate commercial or customized database to be used by computing system 300, and may also include query tools and other management software for managing database 308. Further, input/output interface 310 may be provided for a user or users to input information into computing system 300 or for the user or users to receive information from computing system 300. For example, input/output interface 310 may include any appropriate input device, such as a remote control, a keyboard, a mouse, a microphone, a video camera or web-cam, an electronic tablet, voice communication devices, or any other optical or wireless input devices. Input/output interface 310 may include any appropriate output device, such as a display, a speaker, or any other output devices.

Storage unit 312 may include any appropriate storage device to store information used by computing system 300, such as a hard disk, a flash disk, an optical disk, a CR-ROM drive, a DVD or other type of mass storage media, or a network storage. Further, communication interface 314 may provide communication connections such that computing system 300 may be accessed remotely and/or communicate with other systems through computer networks or other communication networks via various communication protocols, such as TCP/IP, hyper text transfer protocol (HTTP), etc.

The components of the system 200 may use a single computing system 300, or each unit may use a computing system 300 separately. The components of the system 200 may also use a component of the computing system 300 separately and share other component of the computing system 300. For example, the online shopping website 202 may use an input/output interface 310 separately, but share the database 308 and/or the storage unit 312 with the unifying shopping cart 210. The components of the system 200 may use any appropriate combination of the one or more computing system 300 and/or any component of the computing system 300.

The components of the system 200 may be located in one location. They may also be located in different locations. The components of the system 200 in the store they served. They may also be located remotely. The connection between the components of the system 200 may be any appropriate connection means, such as computer networks or other communication networks through various communication protocols, such as TCP/IP, hyper text transfer protocol (HTTP), etc.

Returning to FIG. 2, the unifying shopping cart 210 may be an information unit within the system 200. The cart 210, through the connection to other components of the system 200, may receive an instruction from a customer to add/remove a product from the cart 210. The cart 210 may then sort the instruction based on any appropriate classification criterion. For example, the cart 210 may categorize the ordered item as in store pickup items and delivery items. The cart 210 may also categorize the ordered items based on other classification options, such as package type. The cart 210 may also perform the task of check out and payment. The cart 210 may allow a customer to add products from any device such as the online shop website 202 and the mobile device 204. The cart 210 may also allow the customer to add products from synchronised in-store devices such as the iMirror 206 or Smart Kiosk 208. The cart 210 may also allow users to select part or all of the products to be picked up in the store or home delivery.

The mobile device 204 may be any compatible device with a mobile app installed thereon. For example, the mobile device 204 may be a smart phone, an iPad, a tablet, or a portable computer. The mobile app may be appropriate software that enables the customer to establish communication with the system 200 to perform appropriate activities in a store. The iMirror 206, the smart kiosk 208, and the tracking system 212 will be described in more detail below.

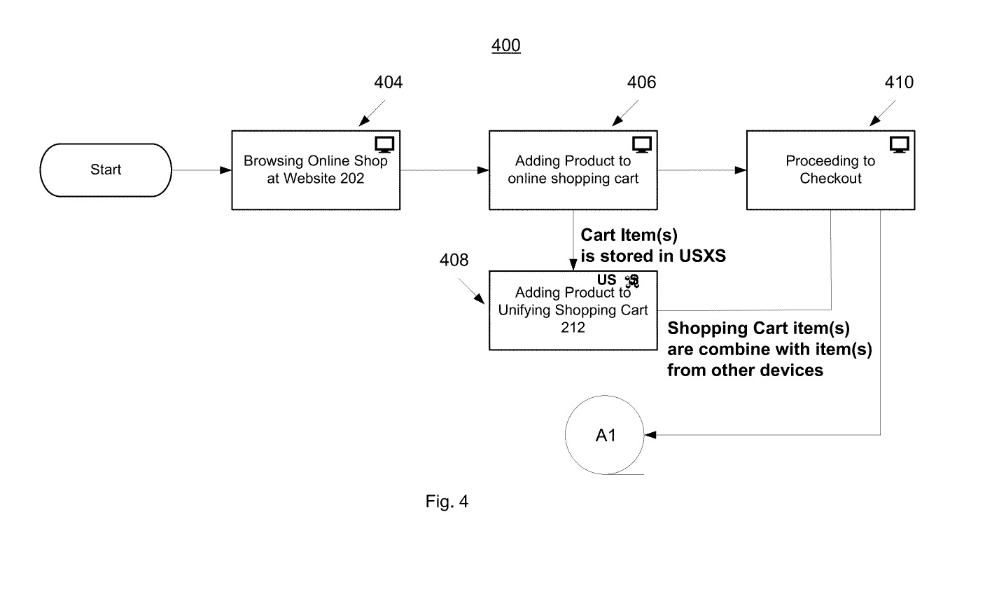

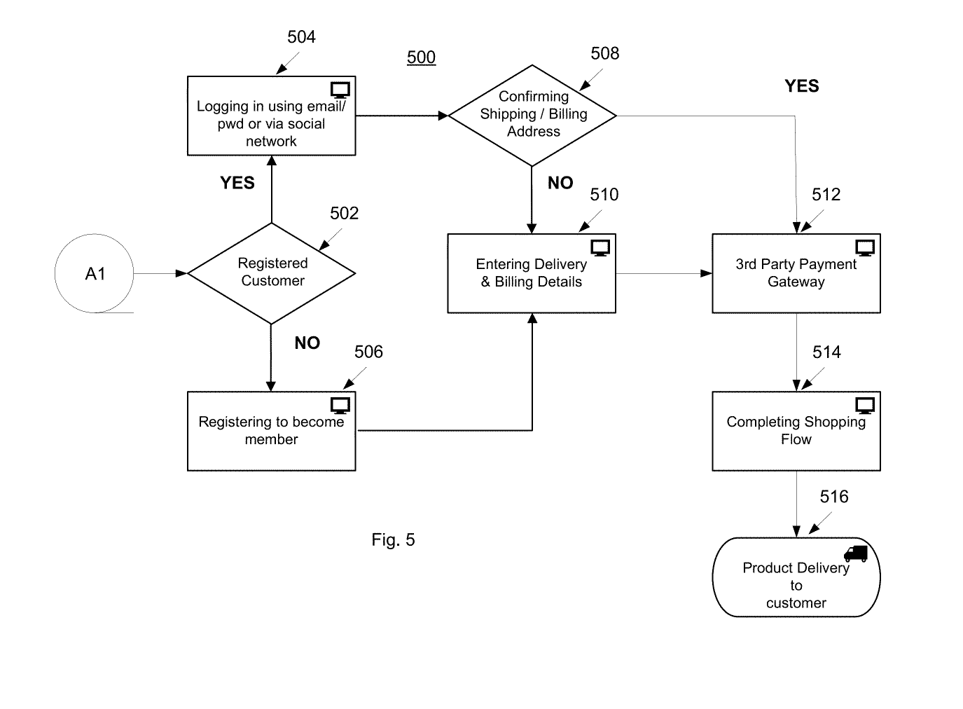

FIG. 4 illustrates an exemplary online shopping process 400 consistent with the disclosed embodiments. As shown in FIG. 4, a customer may browse online shop at the website 202 (404). The customer may add the product to online shopping cart (406). The items from online shopping may be added into the unifying shopping cart 210 (408). The customer may proceed to checkout either from online shopping cart or from the unifying shopping cart (410). The checkout process is shown in FIG. 5.

FIG. 5 illustrates an exemplary checkout process 500 consistent with the disclosed embodiments. As shown in FIG. 5, the system 200 may determine whether the customer is a registered customer (502). If the customer is registered, the customer may login use any appropriate methods (504). In certain embodiments, the customer may log in use email (username) and password may or use social network account such as Facebook, Linkedln, or any other social network account. The customer may be required to confirm shipping and/or billing address (508). If the customer confirms, the customer may be proceed to make a payment (512). If the customer does not confirm or wishes to make a change, the customer may enter delivery and/or billing detail (510).

If the customer is not a registered member, the customer may be asked to register to become a member (506). The newly registered customer may be asked to enter delivery and/or billing details (510). The customer who enters delivery and/or billing details, whether newly registered or not, may proceed to make a payment (512). The customers may make a payment using any appropriate methods, such as credit card, ATM card, pre-deposit account, or third party payment such as PayPal. In certain embodiment, the customer makes payment using a third party payment gateway such as PayPal. The shopping flow may be completed (514). The ordered product may be disposed according to customer's decision (516). For example, the product may be delivered to a party specified by the customer, or a party specified by the customer may pick up the product in store. The product may be disposed in any appropriate way.

The steps in the process 400 and 500 may be organized in any appropriate order. For example, a registered customer may log in (504) before adding product to online shopping cart (406). The customer may make a payment (512) after the ordered product is disposed (516).

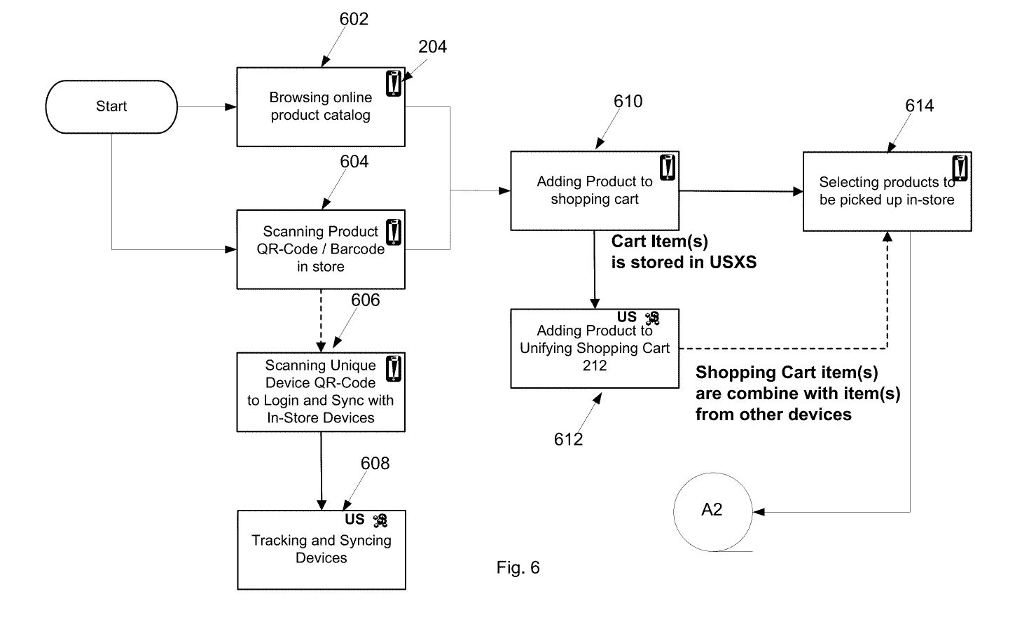

FIG. 6 illustrates an exemplary mobile app shopping process 600 consistent with the disclosed embodiments. As shown in FIG. 6, a customer may browse online product catalogue using the mobile device 204 (602). The customer may browse the catalogue using any appropriate method. For example, the customer may browse using an internet browser on the mobile device. The customer may also browse using a mobile app specifically designed for the mobile app shopping. While in store, the customer may also use the mobile device to scan product (604). The customer may scan the product using any appropriate methods, such as bar code scanning or Quick Response code (QR)-code scanning The mobile app enabled mobile device 204 may include an mobile app to perform the task of product code scanning

The customer may also scan a unique device code of the device 204 to login the system 200 (606). Thus, the device 204 may sync with the in store device while the customer is shopping in store. The tracking system 210 may track the device 204 and sync the device 204 (608). The product may be added to a shopping cart (610). The product may also be added to the unifying shopping cart 210 (612). The customer may select the product to be picked up in store (614).

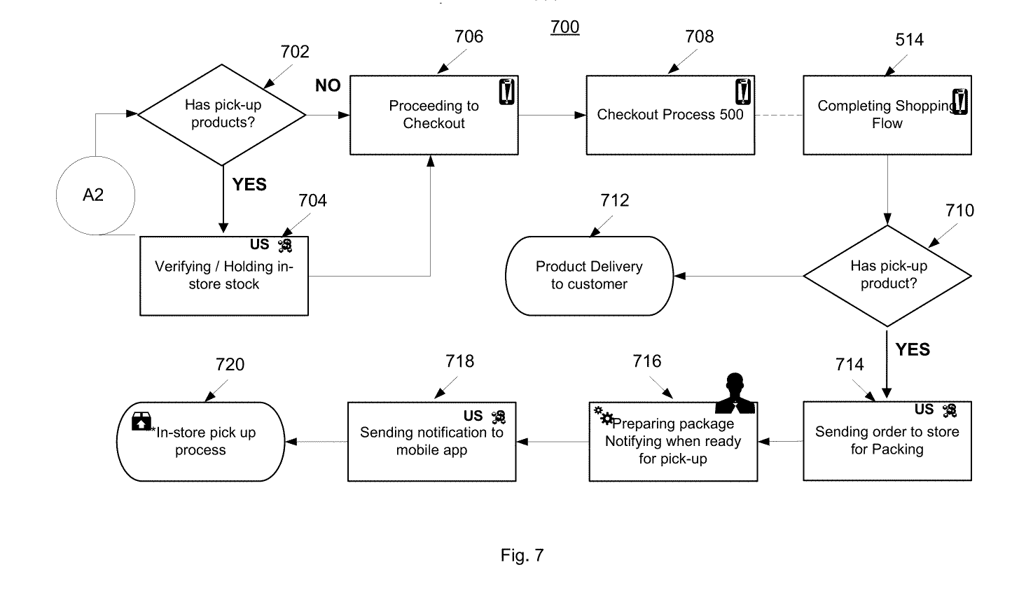

FIG. 7 illustrates an exemplary mobile app check out process 700 consistent with the disclosed embodiments. As shown in FIG. 7, the system 200 determines whether there is any pick-up product (702). If there is pick-up product, the system 200 may verify the availability and/or hold the in store stock of the product (704). The system may proceed to checkout (706). The checkout process 500 may be implemented for checkout (708). The checkout process 500 may be modified to fit the in store shopping need. When the shopping flow is completed (514), the system 200 may determine whether there is pick-up product (710). If there is not, the system 200 may arrange the product to be disposed (712). The disposing process 712 may be similar to the process 516.

If there is any pick-up product, the system 200 may send order to store for pickup preparation (714). The preparation may include packing or any other services a customer may request. The store may have the product prepared for pick-up and notify the customer when the product is ready for pick-up (716). The notification may be sent to the mobile device 204 (718). The customer may proceed to in-store process.

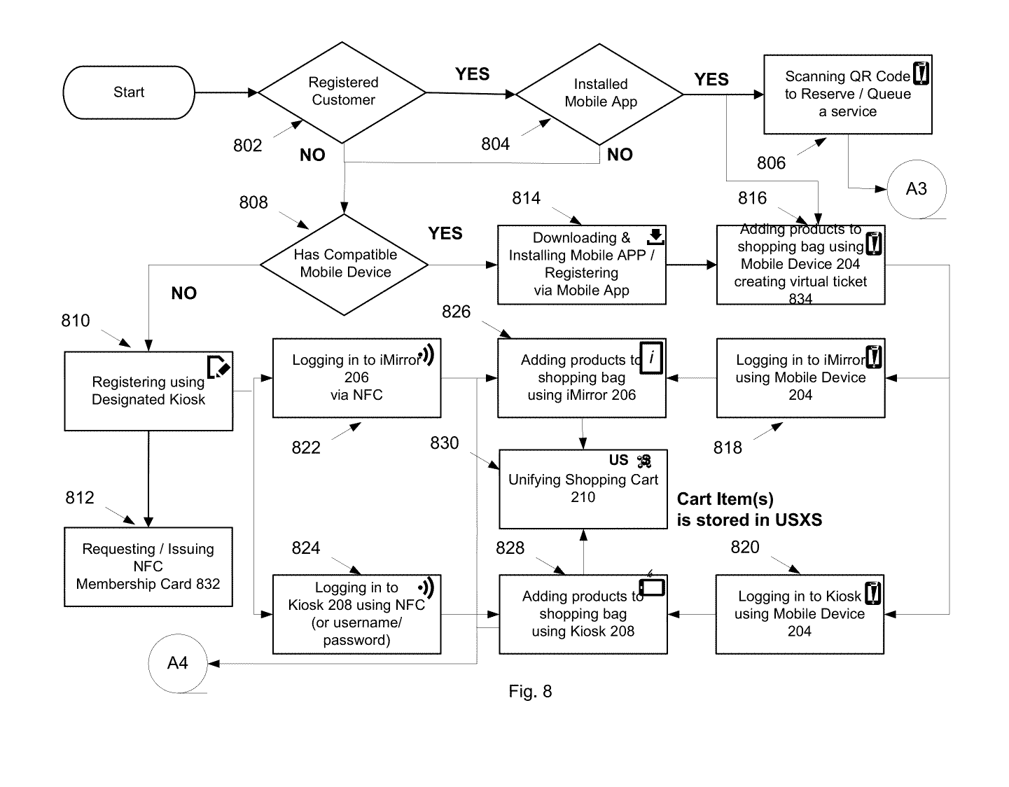

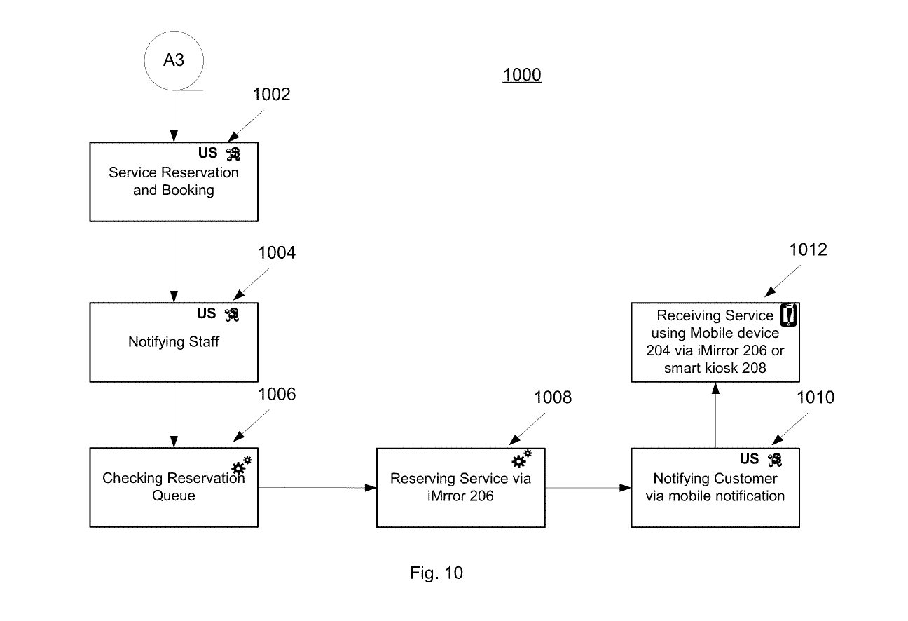

FIG. 8 illustrates an exemplary in store shopping process 800 consistent with the disclosed embodiments. As shown in FIG. 8, the system 200 first determines whether a customer is a registered customer or not (802). For the registered customer, the system 200 inquires whether the customer has the mobile device 204 (804), that is, whether the customer has installed the mobile app on a compatible device. For the customer equipped with the mobile device 204, the system 200 may scan the QR code on mobile device to reserve/queue a service (806). The service process will be described in FIG. 10 and accompanying text. The customer with the mobile device 204 may also scan the product using the mobile device 204 for shopping (816). A virtual ticket 834 may be created. The virtual ticket 834 may be any appropriate recognizable file that may be store in the mobile device 204 and readily retrievable for recognition. For example, the service ticket 416 may be a bar code, or a QR code that may be recognized by a reading device.

For unregistered customer or customer without the mobile device 204, the system 200 inquires whether the customer has compatible mobile device or wishes to use compatible mobile device (808). For customer who wishes to use his/her mobile device, the system 200 may require the customer to download and install the mobile app and register through the mobile app (814). The mobile device becomes the mobile app enabled mobile device 204. The device 204 may be used to scan and add products to shopping bag (816).

For customers who does not have a compatible mobile device or who does not wish to use his or her compatible mobile device, they may register in store in a designated kiosk (810). The customer may request and the store may issue a customer communication device 832 with the capability to establish communication with the system 200 (812). In certain embodiments, the device 832 may be a member ship card using a near field communication (NFC) to establish communication. The customer equipped with the communication device 832 may log in to iMirror 206 through the communication between the device 832 and the iMirror 206 (822). The customer may also log in to iMirror 206 using other methods, such as inputting username and/or password. The customer equipped with the communication device 832 may log in to smart kiosk 208 through the communication between the device 832 and the smart kiosk 208 (824). The customer may also log in to smart kiosk 208 using other methods, such as inputting username and/or password.

The customer may also log in to iMirror 206 using mobile device 204 (818) or to smart kiosk 208 using mobile device 204 (820). After logging in to the iMirror 206 (818 or 822) or the smart kiosk 208 (820 or 824), the customer may add products to shopping bag using iMirror 206 (826) or smart kiosk 208 (828). The shopped products may be added to the unifying shopping cart 210 (830).

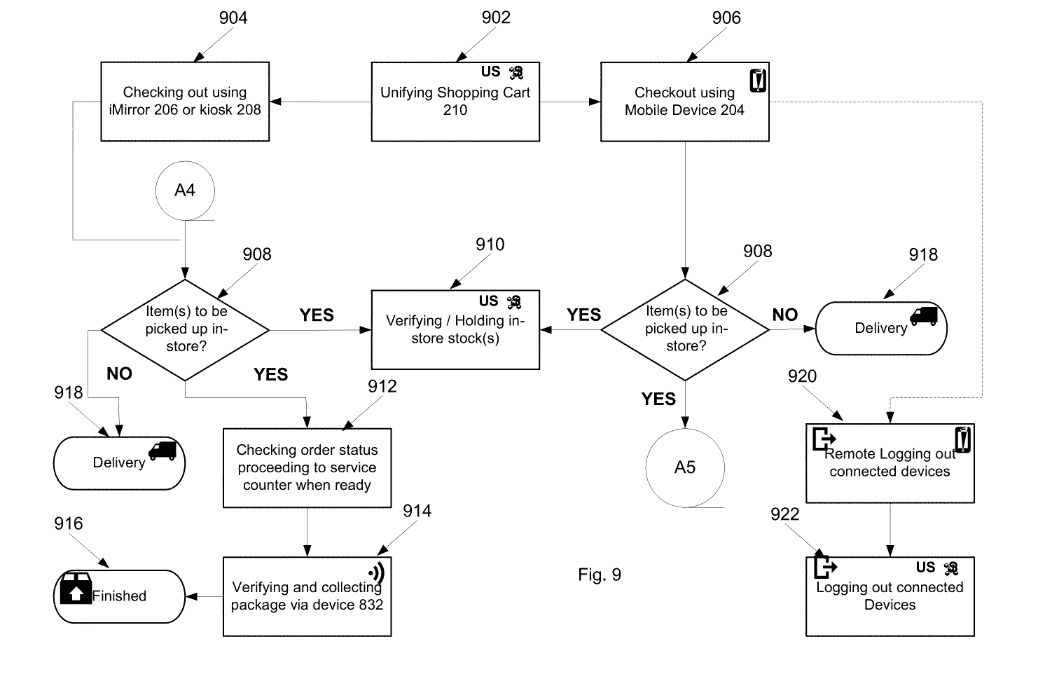

FIG. 9 illustrates an exemplary in store shopping check out process 900 consistent with the disclosed embodiments. As shown in FIG. 9, the products to be checked out may be stored in the unifying shopping cart 210 (902). The products from unifying shopping cart 210 may be checked out using iMirror 206 or kiosk 208 (904). The products may also be checked out directly from iMirror 206 or kiosk 208 (A4). The products in the shopping cart 210 may also be checked out using mobile device 204 (906).

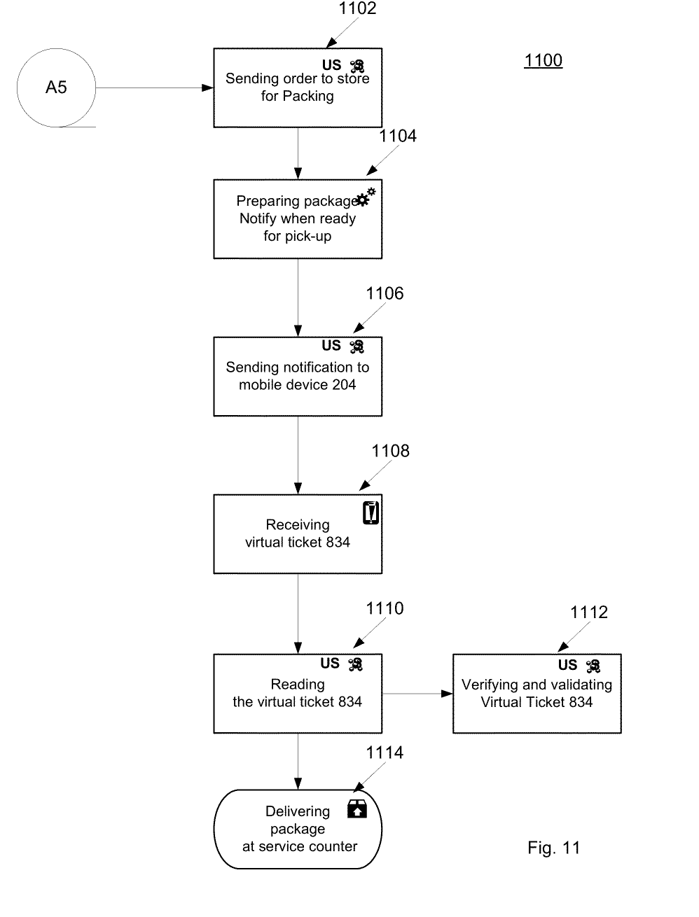

During the checkout, the system 200 inquires whether the product is to be picked up (908). For pick-up products, the system 200 verifies and holds the in store stock (910). The customer using mobile device 204 may proceed to pick up process. The check out process will be described in detail in FIG. 11 and accompanying text. The customer using the device 832 may check order status on the iMirror 206 or kiosk 208 (912). The customer may proceed to the service station when the pick-up product is ready (912). The customer may verify and collect his or her product using the device 832 (914). After pick-up, the shopping process may be finished (916).

For the products not to be picked up in store, the system 200 may send instruction for the products to be delivered (918). The delivery 918 may be similar to the delivery process 516.

When the customer uses the mobile device 204 to check out, the customer may log out connected devices remotely (920). The system 200 may log out the connected devices (922).

FIG. 10 illustrates an exemplary service process 1000 consistent with the disclosed embodiments. As shown in FIG. 10, a service may be reserved and booked (1002). A staff member may be notified (1004). The service reservation and queue status may be checked (1006). The service status checking may be performed by a staff member or by the system 200. The system 200 may check the status through monitoring the status of the device, such as iMirror 206 or smart kiosk 208 associated with the service station. When a service slot becomes available, the system 200 or the staff member may reserve the service (1008). The staff member may reserve the service using iMirror 206 or smart kiosk 208. The customer may be notified about the availability of the service slot (1010). The customer may receive the service by using the mobile device 204 through the iMirror 206 or smart kiosk 208 associated with the service station (1012).

In certain embodiments, the service requested is the use of changing room. The customer may be notified when the changing room is ready. The notification may be in any appropriate format. For example, the notification may be sent to the mobile device 204, or the iMirror 206 or the smart kiosk 208 the customer is using. The notification may also be sent using a public announcement system. The customer may go to the changing room and open the changing room using the mobile device 204 or the customer communication device 832 to open the changing room by the interaction between the mobile device 204 or the communication device 832 and the iMirror 206 or the smart kiosk 208 located by the changing room. The customer may also open the changing room by manually input the customer information on the iMirror 206 or the smart kiosk 208 located by the changing room.

FIG. 11 illustrates an exemplary pick up process for a customer using the mobile device 204. For pick-up products, the order is sent to store for preparation (1102). In certain embodiments, the preparation is to pack the products. The service as requested may be prepared and the customer is notified when the product is ready for pick up (1104). A notification may be sent to the mobile device 204 (1106). The customer may present the virtual ticket 834 and the system 200 may receive the ticket 834. The system 200 may read the virtual ticket 834 (1110) and verify and validate the virtual ticket 834 (1112). The customer may receive the pick-up product delivered at service counter (1114).

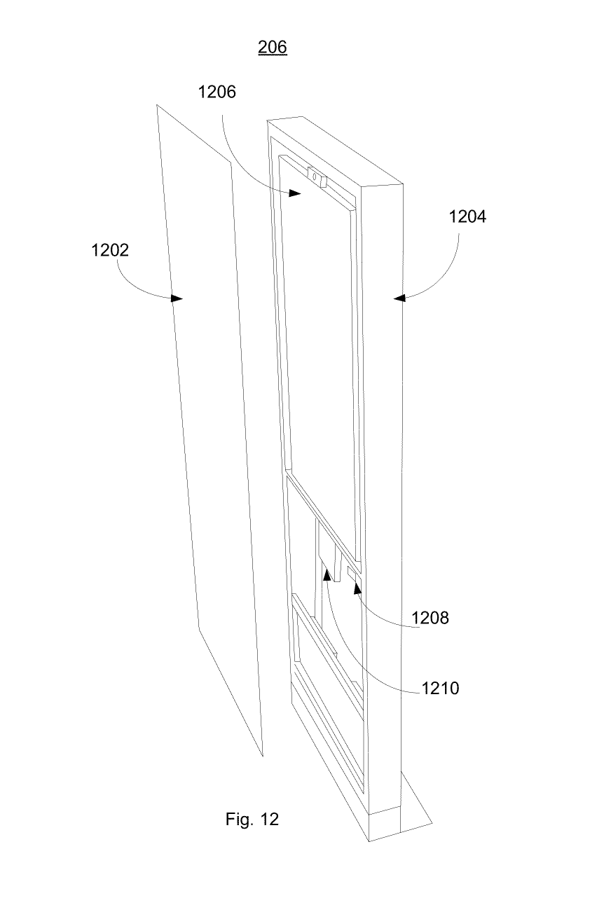

FIG. 12 illustrates an exemplary iMirror 206 consistent with the disclosed embodiments. As shown in FIG. 12, the iMirror device 206 may include a two way mirror 1202, a mirror frame 1204, an interacting device 1206, a receiving member 1208, and an antenna 1210 for a product recognition member. The interacting device 1206, the receiving member 1208 and the antenna 1210 may be located within the mirror frame 1204 behind the mirror 1202.

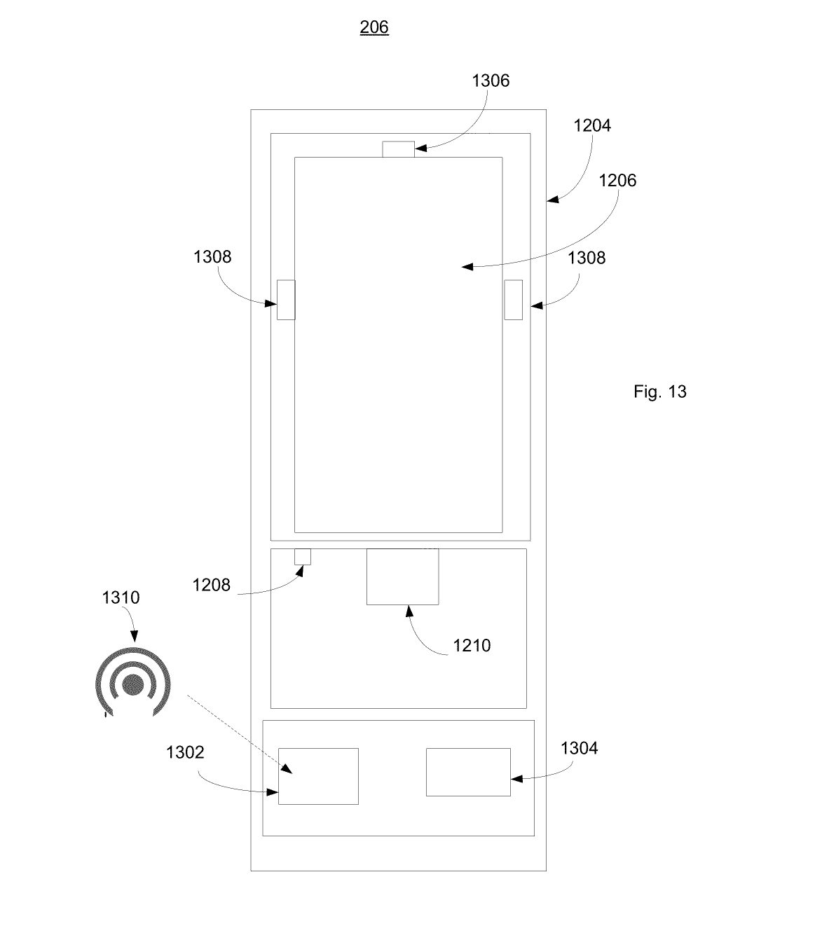

FIG. 13 illustrates a front view of an exemplary iMirror device 206 consistent with the disclosed embodiments with the two-way mirror 1202 removed. As shown in FIG. 13, the iMirror device 206 may include the mirror frame 1204, the interacting device 1206, the receiving member 1208, a product recognition member 1302, the antenna 1210 for the product recognition member 1302, a processing member 1304, a first camera 1306, and a second camera 1308. The interacting device 1206, the receiving member 1208, the antenna 1210, the recognition member 1302, the processing member 1304, the first camera 1306, and the second camera 1308 may be located at any appropriate position and may be arranged in any appropriate pattern.

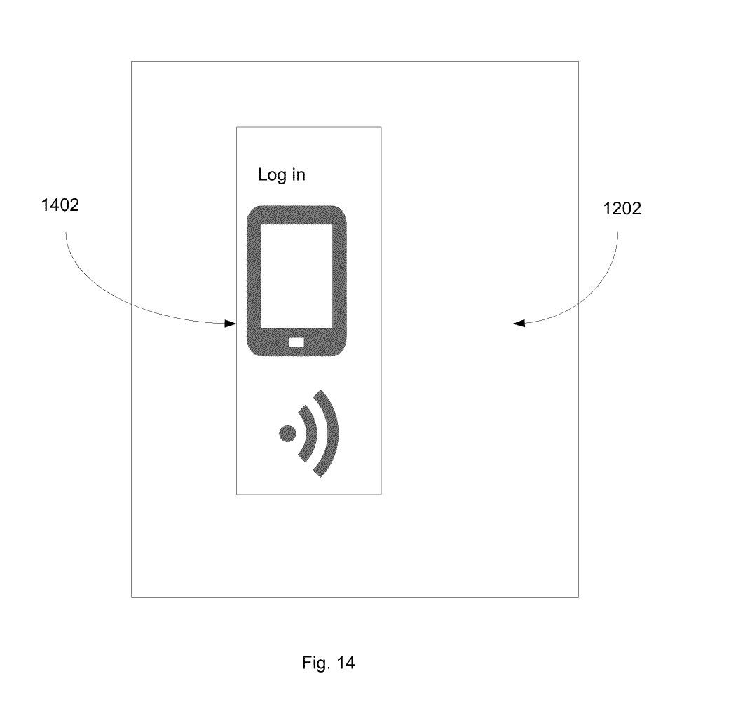

A customer may use the two way mirror 1202 as a regular mirror. Meanwhile, the mirror 1202 may not interfere with the device or component in the mirror frame 1204 behind the mirror 1202 from detecting and/or interacting with customer and/or product in front of the mirror 1202. For example, the first camera 1306 may sense motion and detect face feature of a customer through the mirror 1202. As shown in FIG. 14, the interacting device 1206 may have a displaying member 1402 to display interacting menu for a customer to use. For example, the interacting device 1206 may ask the customer to scan a QR code on the mobile device 204 or scan his/her membership card 832 to log in. The customer may see through the two-way mirror 1202 to read the interacting menu on the displaying member 1402 given by the interacting device 1206.

The displaying member 1402 may be any appropriate device to display the any information. In certain embodiments, the displaying member may display the products or services available. In certain embodiments, the displaying member 1402 may allow the customer to interact with the iMirror 206. For example, the displaying member 1402 may be a touch screen. The customer may choose products/service from the menu displayed on the display member 1402. The displaying member 1402 may be made from any appropriate material. In certain embodiments, the displaying member 1402 may be made from LED (Light-emitting diode) and touch film. The customer may select an item and/or a service by touching the iMirror 206.

Returning to FIGS. 12 and 13, the receiving member 1208 may be any appropriate device that can receive customer information. For example, the receiving member 1208 may be a reader that read a QR code on a customer's mobile device 204. The receiving member 1208 may also be a card reader to receive the information store on the customer communication device 832 of a customer. In certain embodiments, the receiving member 1208 is a NFC card reader. The receive member 1208 may be any other appropriate device using any appropriate method to acquire customer information.

A customer may log in the system 200 through the iMirror device 206 through the interaction between the receiving member 1208 and the customer communication device 832. A customer may also log in the system 200 through the iMirror device 206 through inputting username and/or password. The interacting device 1206 may display the login request by requiring the customer enter username and/or password on the displaying member 1402. The customer may enter his/her login information through the interacting device 1206.

The product recognition member 1302 may be any appropriate device that may recognize an item of product by reading a product identification device 1310 on the product. The identification device 1310 may be any appropriate device can establish communication with other components of the system 200, such as the product recognition member 1302. In certain embodiments, the identification device 1310 may be a product tag with Radio-frequency Identification (RFID). Any other appropriate methods may be used for the device 1310 for the communication between the device 1310 and any other component of the system 200. In certain embodiments, the recognition member 1302 may be a RFID reader. The product recognition member 1302 may be any appropriate device using any appropriate method to identify an item of product.

A customer may also identify an item through the interacting device 1206. The interacting device 1206 may display available products and/or services on the displaying member 1402 and the customer may choose from the menu. For example, the customer may order coffee or food, which the customer may not carry to the iMirror device 204, from the interacting device 1206.

The customer may place a request through the iMirror device 204. The request may be any appropriate request a customer may have in a store. For example, the request may include purchase order request, fitting room reservation request, and sales person help request. The customer may place any appropriate request in a store. The interacting device 1206 may display a request menu on the displaying device 1402. The customer may use any appropriate method to choose the request. For example, the customer may touch the service/request available on the screen. The customer may also scan the QR code on the mobile device 204 or communication device 832 according to the instruction displayed on the displaying device 1402.

The first camera 1306 may sense motion in front of the iMirror 206. In certain embodiments, the interacting device 1206 may be activated after the first camera 1306 detects motion towards the iMirror 206. Thus, the iMirror 206 may display an interacting menu on the displaying member 1402 when a customer arrives in front of the iMirror 206. The first camera 1306 may also capture the face features of the customer and send the information to the system 200. The system 200 may recognize the customer by comparing the face features of the customer to those in the database. In certain embodiments, the first camera 1306 is located on the top of the mirror frame 1204. The first camera may also be located at any other appropriate locations.

In certain embodiments, the second camera 1308 may be located on the side of the iMirror 206. The camera 1308 may also be located at any appropriate locations. The second camera 1308 may or may not have the same functions as the first camera 1306. The second camera 1308 may take snapshot of the customer in front of the iMirror 206. The images captured by the first camera 1306 and the second camera 1308 may be sent to the system 200. For certain products, such as clothing, the system 200 may generate images to imitate the trying on of the item by the customer and send the virtual trying on image to any appropriate device, such as the customer's mobile device 204, or the displaying member 1402.

The processing member 1304 may connect to the interacting device 1206, the first camera 1306, the second camera 1308, the receiving member 1208, and the product recognition member 1302. In certain embodiments, the processing member 1304 is a computing system similar to the computing system 300. The processing member 1304 may include one or more component similar to the components of the system 300. The processing member 1304 may connect to other components of the shopping system 200 through any appropriate method. In certain embodiment, the processing member 1304 is connected to the shopping system 200 through wireless network connection. The processing member 1304 may receive, process, analyze, and transmit information/data it receives from the components of the iMirror device 206 to other component of the system 200. For example, the processing member 1304 may receive a purchase order or a fitting room reservation request to the unifying shopping cart unit 210 and/or the tracking system 212. The processing member 1304 may receive, process, analyze, and transmit information/data/instruction from other components of the system 200 and send such information/data/instruction to the components of the iMirror 206. For example, the processing member 1304 may receive an instruction from the tracking system 212 that a fitting room becomes available in certain time. The processing member 1304 then may send the instruction to the interacting device 1206, which in turn may display the instruction on the displaying member 1402.

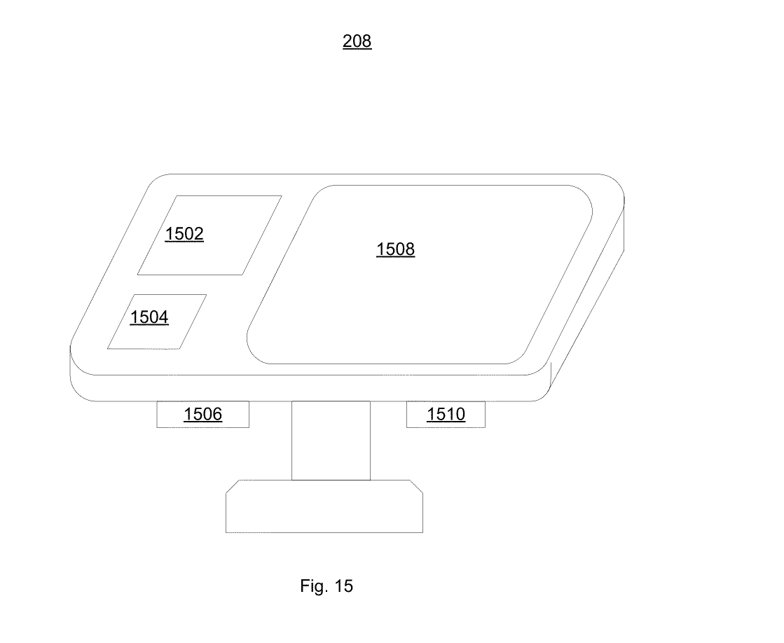

FIG. 15 illustrates an exemplary smart kiosk 208 consistent with the disclosed embodiments. As shown in FIG. 15, the smart kiosk 208 may include the receiving member 1502, the product recognition member 1504, a kiosk interacting device 1506, a kiosk displaying member 1508, and a kiosk processing member 1510. The receiving member 1502 and the product recognition member 1504 may be similar to those on the iMirror 206, respectively, namely, the receiving member 1208 and the product recognition member 1302. The kiosk interacting device 1506 may be similar to the interacting device 1206, the kiosk display member 1508 may be similar to the displaying member 1402, and the kiosk processing member 1510 may be similar to the processing member 1304. In general, the kiosk 208 may perform the similar function as the iMirror 206. The receiving member 1208, the product recognition member 1302, the kiosk interacting device 1506, the kiosk displaying member 1508, and the kiosk processing member 1510 may be located in any appropriate positions and may be arranged in any appropriate pattern. For example, the processing member 1510 may be placed underneath the displaying member 1508 and may be invisible to a customer. In certain embodiments, the smart kiosk 208 may be a NFC-enabled Android table. The smart kiosk 208 may be located at any appropriate locations. In certain embodiments, the smart kiosk 208 is located at the small goods counter, such as cosmetics, small leather goods, with an NFC label or sticks.

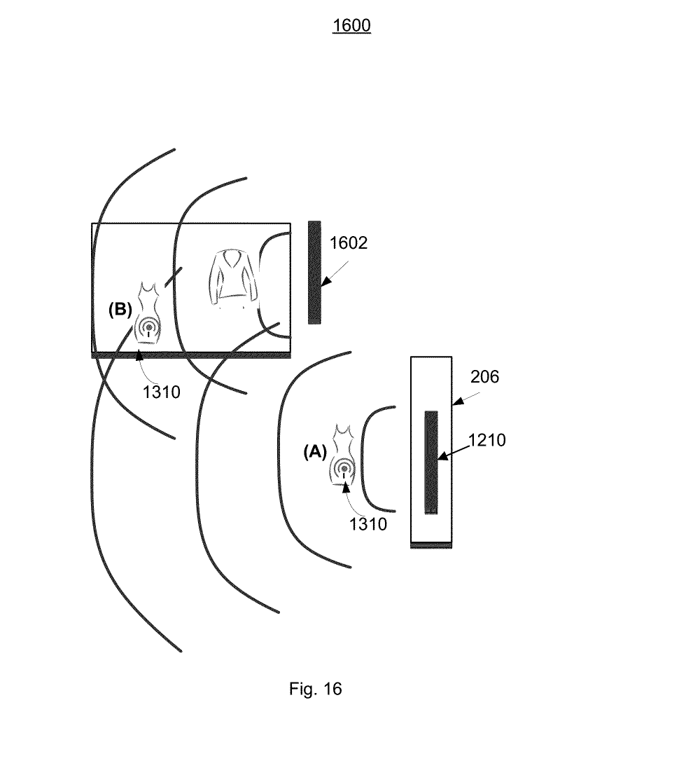

FIG. 16 illustrates an exemplary detection background removing system 1600 consistent with the disclosed embodiments. As shown in FIG. 16, the system 1600 may include the iMirror device 206 and a second antenna 1602. The antenna 1210 within the iMirror device 206 may detect both an item A, which is carried to the iMirror device 206 by a customer with the product identification device 1310, and an item B, which is located on a shelf nearby also with the product identification device 1310. Thus, the iMirror device 206 may create inaccurate information that two items are selected. The second antenna 1602 may detect only the item B on the shelf. The detection by the second antenna 1602 may be sent to the tracking system 212. The system 200 may then eliminate the item B for further processing. The communication between the antenna 1602 and any component of the system 200 may be established by any appropriate communication method. In certain embodiments, the communication between the antenna 1602 and the components of the system 200 may be through a wireless network.

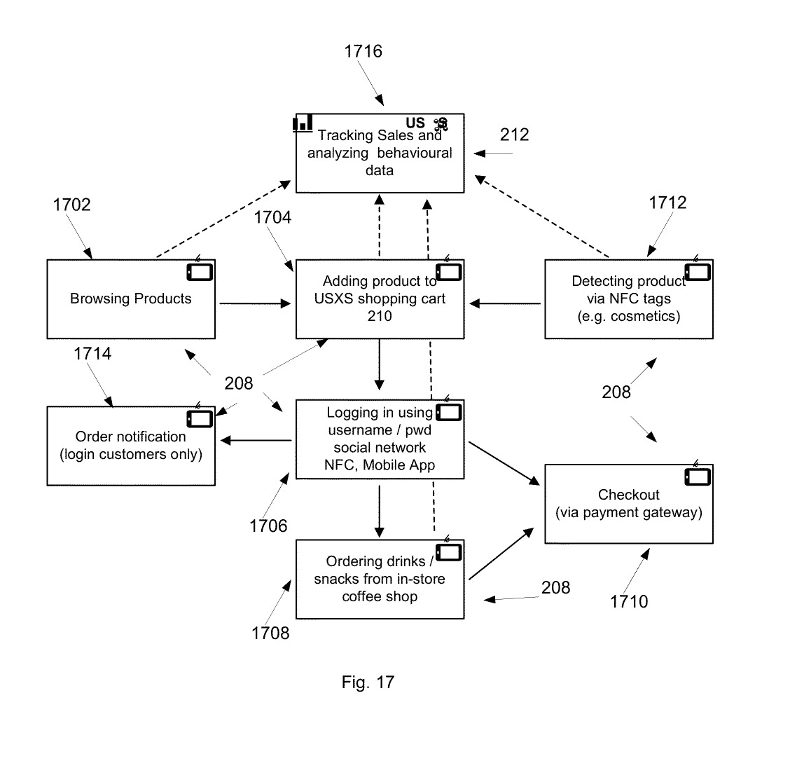

FIG. 17 illustrates an exemplary function of the tacking system 212 and the smart kiosk 208 consistent with the disclosed embodiments. As shown in FIG. 17, the smart kiosk 208 may perform various functions. For example, a customer may browse products using the smart kiosk 208 (1702). The customer may add product to shopping cart 210 (1704), may log in through the smart kiosk 208 (1706), may order food or drink (1708), and may check out (1710). The system 200 may perform certain functions using the smart kiosk 208, such as detecting the products a customer chooses (1712) or sending order notification (1714). The smart kiosk 208 may perform any appropriate functions. For example, a customer may register as a member using a smart kiosk 208 and a staff may register and issue membership for a customer. The smart kiosk 208 may send various type of information to the tracking system 212 so the tracking system 212 may track the sales and analyze behavior data (1716).

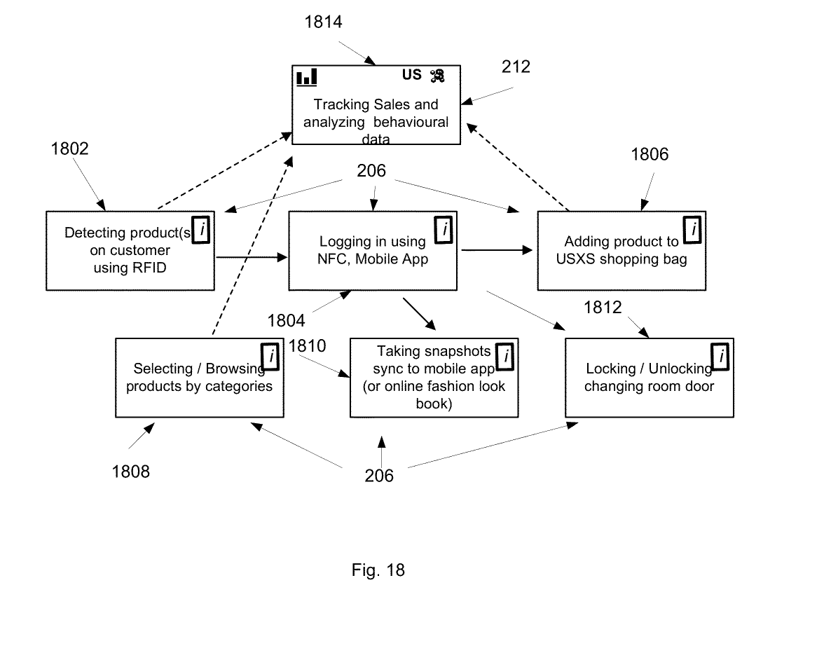

FIG. 18 illustrates an exemplary function of the tracking system 212 and the iMirror 206 consistent with the disclosed embodiments. As shown in FIG. 18, the smart kiosk 208 may perform various functions. For example, a customer may browse products using the iMirror 206 (1808). The customer may add product to shopping cart 210 (1806), may log in through the smart kiosk 208 (1804), may take snapshots sync to mobile app (1810), and may lock and unlock a fitting room (1812). The system 200 may perform certain functions using the iMirror 206, such as detecting the products a customer chooses (1802). The smart kiosk 208 may perform any other appropriate functions. The iMirror 206 may send various type of information to the tracking system 212 so the tracking system 212 may track the sales and analyze behavior data (1814).

As shown in FIGS. 17 and 18, the tracking system 212 may collect information of the customer's activities. The behavior pattern of the customer may be collected and analyzed by the tracking system 212. The tracking system may analyze the information/data received. For example, the tracking system 212 may analyze the rate by which a customer made a purchase decision after viewing/trying certain items. The tracking system 212 may also analyze the behavior of certain customer. The tracking system 212 may conduct any analysis related to customer, product, and activities related to customers and/or product. The tracking system 212 may collect the information/data and/or conduct analysis on an on-going basis as the ongoing shopping activities. The tracking system 212 may also conduct analysis on a pre-determined time interval and generate reports.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

For example, in addition to a store, the system may be used in other type of public goods or services provider such as cafeteria, private club, restaurant, and other venues. When used in cafeteria, the system may be used for people to order food, drink, or services.

What is claimed is:

1. A shopping system, comprising:
a customer interaction device for communication between a customer and the shopping system, the customer interaction device interacting with the shopping system to conduct an activity in a store;
an interactive service device located in a store, the interactive service device having a receiving member to receive an identification information of the customer, a displaying member and an interacting device to allow the customer to interact with the shopping system to conduct the activity in the store;
an unifying shopping cart configured to integrate purchase order information of the customer, and
a tracking system to track the activities of the customer.

2. The shopping system according to claim 1, further comprising:
a product identification device located on a product item in the store, the product identification device being communicable with the shopping system; and
a product reading device to communicate with the product identification device to identify the product item.

3. The shopping system according to claim 2, wherein the interactive service device is an iMirror, further comprising:
a first antenna configured to detect a communication signal from the product identification device.
a second antenna configured to detect exclusively a communication signal from the product identification device that is located on shelf, wherein:
the system remove the product item detected by the second antenna from further processing.

4. The shopping system according to claim 2, wherein the interactive service device is an iMirror, further comprising:
a first camera configured to sense motion and detect face feature of a customer.

5. The shopping system according to claim 4, further comprising:
a second camera configure to take a picture of the customer, wherein:
the shopping system is configured to generate a virtual image of the customer trying on a product item and display the virtual image of the customer trying on a product item.

6. The shopping system according to claim 1, wherein the customer interaction device is an app-enabled mobile device.

7. The shopping system according to claim 1, wherein the customer interaction device is a customer communication device with the capacity to communicate with the shopping system.

8. The shopping system according to claim 7, wherein the customer communication device communicates with the shopping system through near filed communication function.

9. The shopping system according to claim 2, wherein the product identification device communicates with the system using radio frequency identification.

10. The shopping system according to claim 1, wherein the interactive service device is selected from the group consisting of an iMirror and a smart kiosk.

11. The shopping system according to claim 1, wherein the unifying shopping cart unit is configured to sort a shopping order according to a criterion.

12. The shopping system according to claim 1, wherein:
the interactive service device is configured to receive a service request, the shopping system is configured to process the service request and send a service instruction and a notification, and the interactive service device is configured to recognize the service request and permit the service delivery.

13. The shopping system according to claim 1, further comprising:
a virtual ticket created by the shopping system; wherein:
the shopping system recognizes the virtual ticket to deliver product to the customer.

14. The shopping system according to claim 1, further comprising:
a tracking system configured to collect the behavior information of a customer in store.

15. The shopping system according to claim 15, wherein:
the tracking system is configured to track and analyze the activities and behavior of the customer.

16. A shopping process using a shopping system, comprising the steps of:
creating a customer interaction device for communication between a customer and the shopping system, the customer interaction device interacting with the shopping system to conduct an activity in a store;
interacting with the customer interaction device using an interactive service device located in a store, the interactive service device having a receiving member to receive an identification information of the customer, a displaying member and an interacting device to allow the customer to interact with the shopping system to conduct an activity in the store;
integrating order information of the customer in an unifying shopping cart unit; and
providing service to the customer under the instruction of the shopping system.

17. The process according to claim 16, further comprising:
identifying a product item using a product reading device to communicate with a product identification device located on the product item in the store, the product identification device being communicable with the shopping system.

18. The process according to claim 16, wherein:
the interactive service device is selected from a group consisting of an iMirror and a smart kiosk.

19. The process according to claim 16, wherein:
the customer interaction device is selected from a group consisting of an app-enabled mobile device and a customer communication device with the capacity to communicate with the shopping system, wherein the app-enabled mobile device is created by downloading and installing the app on a compatible mobile device.

20. The process according to claim 16, further comprising:
receiving a service request;
processing the service request;
sending a service instruction and a notification;
recognizing the service request; and
permitting a service delivery

21. The process according to claim 20, further comprising:
creating a virtual ticket for service identification by the shopping system; and
recognizing the service requesting customer by recognizing the virtual ticket by the shopping system.

22. The process according to claim 20, comprising:
queuing the service request received; and
sending a notification to a device selected from the group consisting of the customer interaction device and the interactive service device when the requested service is available.
